(19) United States
(12) Patent Application Publication
(10) Pub. No.: US 2014/0100874 A1
(43) Pub. Date: Apr. 10, 2014

(54) METHOD FOR DISPLAYING LINKED FAMILY HEALTH HISTORY ON A COMPUTING DEVICE

(71) Applicant: Intermountain Invention Management, LLC, Salt Lake City, UT (US)

(72) Inventor: Grant M. Wood, Salt Lake City, UT (US)

(73) Assignee: Intermountain Invention Management, LLC, Salt Lake City, UT (US)

(21) Appl. No.: 14/045,530

(22) Filed: Oct. 3, 2013

Related U.S. Application Data
(60) Provisional application No. 61/710,471, filed on Oct. 5, 2012.

(51) Int. Cl. G06F 19/00

(52) U.S. Cl. CPC G06F 19/322
USPC 705/3

(57) ABSTRACT

A method for displaying a family health history on a computing device is described. The method includes obtaining a first medical record profile. The method includes obtaining one or more family medical record profiles. The method includes establishing a family link between the first medical record profile and the one or more family medical record profiles. Establishing the family link includes obtaining permission to link the first medical record profile and the one or more family medical record profiles. The method also includes displaying the first medical record profile linked to the one or more family medical record profiles.

### RELATED APPLICATIONS

This application is related to and claims priority from U.S. Provisional Patent Application Ser. No. 61/710,471, filed Oct. 5, 2012 for “METHOD FOR DISPLAYING CONSENT BASED FAMILY HEALTH HISTORY ON A COMPUTING DEVICE,” which is incorporated herein by reference.

### TECHNICAL FIELD

The present disclosure relates generally to computers and computer-related technology. More specifically, the present disclosure relates to a method for displaying linked family health history on a computing device.

### BACKGROUND

Computer and communication technologies continue to advance at a rapid pace. Indeed, computer and communication technologies are involved in many aspects of a user's day. Computers commonly used include everything from hand-held computing devices to large multi-processor computer systems.

Computer technology is becoming increasingly important in the medical services environment. For example, computers may assist doctors in treating patients. Also, computer systems may be used in the medical environment to assist doctors in sharing patient information with each other. For example, a medical professional may rely on information obtained directly from a patient as well as information provided by other medical professionals that have treated a patient.

Medical providers often consider the health history of a patient when determining how to treat a patient or perform a certain test. For example, a patient with a family health history of heart disease may be at a greater risk of heart disease, even if a related medical condition in the patient does not presently exist. Thus, a medical professional may find it useful to obtain access to one or more medical profiles of relatives to obtain a family health history of a particular patient. Obtaining this information may be difficult or tedious where information is stored at different locations, or where a medical provider must search through medical records individually in order to determine relevant health information of relatives of a patient. Therefore, improvements in obtaining and displaying a linked family health history may be beneficial.

### BRIEF DESCRIPTION OF THE DRAWINGS

FIG. 1 is a block diagram illustrating one configuration of a computing device for displaying linked family health history;

FIG. 2 is a flow diagram illustrating one configuration of a method for displaying linked family health history;

FIG. 3 is a block diagram illustrating one configuration of a linked family health history display;

FIG. 4 is a block diagram illustrating one configuration of a patient medical record profile display;

FIG. 5 is a block diagram illustrating one configuration of a health profile interface;

FIG. 6 is a flow diagram illustrating a more detailed configuration of a method for displaying linked family health history;

FIG. 7 is a flow diagram illustrating one configuration of a method for generating a health report based on a family health history;

FIG. 8 is table illustrating one configuration of a health history report based on a family health history; and

FIG. 9 illustrates various components of a computing device that may be utilized for displaying linked family health history.

### DETAILED DESCRIPTION

A method for displaying a family health history on a computing device is described. The method includes obtaining a first medical record profile. The method also includes obtaining one or more family medical record profiles. The method also includes establishing a family link between the first medical record profile and the one or more family medical record profiles. Establishing the family link includes obtaining permission to link the first medical record profile and the one or more family medical record profiles. The method also includes displaying the first medical record profile linked to the one or more family medical record profiles.

The method may include generating a risk report for the first medical record profile based on the family link between the first medical record profile and the one or more family medical record profiles. The risk report may be a total risk report based on multiple disease conditions between the first medical record profile and the one or more family medical record profiles. The risk report may also be a disease-specific risk report based on single disease condition between the first medical record profile and the one or more family medical record profiles. The first medical record and the one or more family medical records may be transmitted using HL7 or GEDCOM format.

Obtaining permission to link the medical record profiles may include obtaining permission to access the medical records for each of the medical record profiles. Obtaining permission to access the medical record profiles may include obtaining permission to access only a portion of the medical records for each of the medical record profiles related to a specific disease condition. Obtaining permission to access the medical record profiles may also include obtaining permission for one of the group consisting of a healthcare provider, a disease association, a research study group and a third party application to access the medical record for each of the medical record profiles.

The method may include displaying a health profile interface of the first medical record profile. The health profile interface may include multiple fields including a personal profile field, a disease condition field and associated disease information of the first medical record profile. The method may also include displaying each of the first medical record profile and the one or more family medical record profiles, including displaying one or more icons to indicate disease conditions associated with respective medical record profiles. At least one of the icons may represent a disease category.

Obtaining permission to link the first medical record profile to one or more family medical record profiles may also include sending a request for permission to link the first medical record profile to one or more family medical record profiles to a remote device. Obtaining permission to link the first medical record profile to one or more family medical record profiles may also include receiving permission to link the first medical record profile to one or more family medical record profiles. The permission to link the medical record profiles may also include permission to access medical records of the first medical record profile and one or more family medical record profiles.

An apparatus for displaying a family health history is also described. The apparatus includes a processor and memory in electronic communication with the processor. The apparatus also includes instructions stored in memory. The instructions are executable to obtain a first medical record profile. The instructions are also executable to obtain one or more family medical record profiles. The instructions are also executable to establish a family link between the first medical record profile and the one or more family medical record profiles. Establishing the family link includes obtaining permission to link the first medical record profile and the one or more family medical record profiles. The instructions are also executable to display the first medical record profile linked to the one or more family medical record profiles.

A non-transitory computer-readable medium for displaying a family health history is also described. The computer-readable medium includes executable instructions for obtaining a first medical record profile. The computer-readable medium also includes instructions for obtaining one or more family medical record profiles. The computer-readable medium also includes instructions for establishing a family link between the first medical record profile and the one or more family medical record profiles. Establishing the family link includes obtaining permission to link the first medical record profile and the one or more family medical record profiles. The computer-readable medium also includes displaying the first medical record profile linked to the one or more family medical record profiles.

The systems and methods described herein may facilitate displaying linked family health history of a patient and/or relatives of a patient. As referred to herein, a “patient” may include a patient in the context of health care or any individual associated with a medical record profile. Further, medical records or health records may refer to any personal and/or health-related information that may be included within a medical record profile.

As stated above, the systems and methods disclosed herein may facilitate obtaining and displaying linked family health history. For example, a patient or individual may map a family tree or linked family history displaying multiple generations of ancestors and descendants. Each relative may be associated with a specific medical record profile, indicating information such as personal profiles, health profiles, diseases, conditions, causes of death, etc. This family health information may be used to determine a risk and/or generate a health report for a patient based on conditions or diseases of profiles within the family health history. Additionally, this family health history may be displayed to assist a health professional, clinic or other organization to determine health risks and/or predict the health status of the patient and relatives.

The family health history may be displayed based on permissions obtained from a patient and/or relatives. The patient may grant permission to access certain medical records and/or link a patient medical record profile to one or more family medical record profiles via a consent engine on a computing device. A computing device may also be used to update relevant information in the family health history as it becomes available and/or as permission to access certain records is obtained. The computing device may also import or export health history data of one or more individuals and/or relatives based on consent or permission to access those records. Thus, medical history records may also be shared or protected based on consent of a patient associated with those records.

Various configurations are now described with reference to the figures, where like reference numbers may indicate functionally similar elements. The systems and methods as generally described and illustrated in the figures herein could be arranged and designed in a wide variety of different configurations. Thus, the following more detailed description of several configurations, as represented in the figures, is not intended to limit scope, as claimed, but is merely representative of the systems and methods.

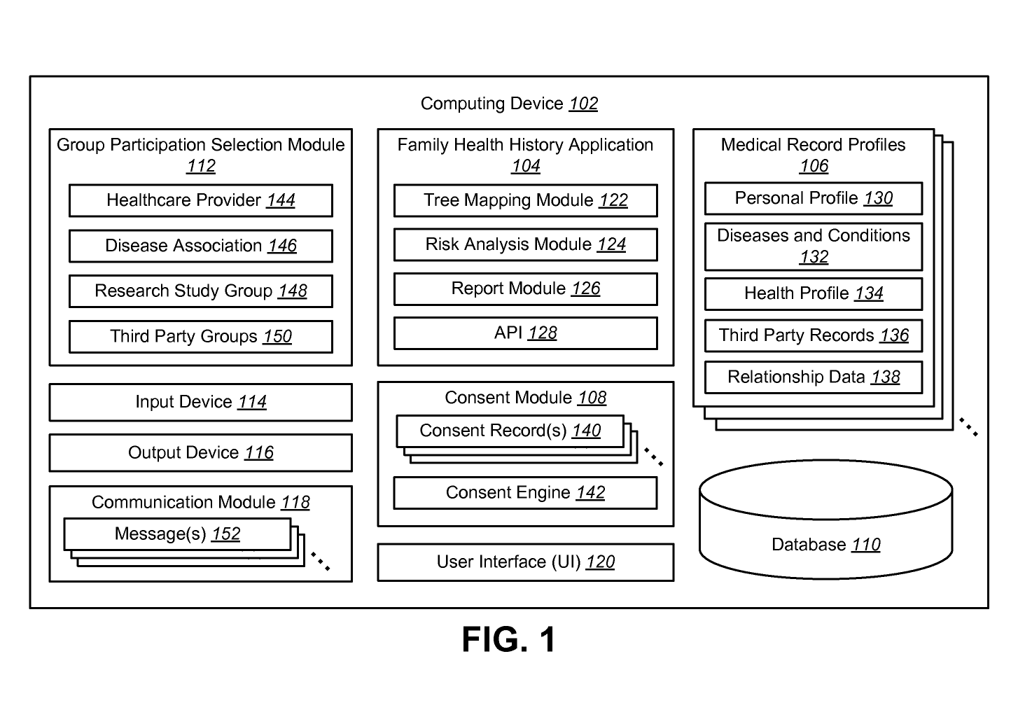

FIG. 1 is a block diagram illustrating one configuration of a computing device 102 for displaying linked family health history. Examples of the computing device 102 may include one or more desktop computers, laptop computers, servers, supercomputers, smartphones, tablet devices, game consoles, e-readers and/or other devices that include memory and a processor. Although several elements are illustrated within the same computing device 102 in FIG. 1, one or more of the illustrated elements may be included in a separate device. For example, the computing device 102 may represent one or more computing devices and/or other devices, where each includes one or more of the components or modules illustrated in FIG. 1.

The computing device 102 may include one or more input devices 114 and one or more output devices 116. Examples of different kinds of input devices 114 include a keyboard, mouse, microphone, remote control device, button, joystick, trackball, touchpad, lightpen, etc. Examples of different kinds of output devices 116 include a speaker, printer, display device, etc.

The computing device 102 may include a family health history application 104, group participation selection module 112, medical record profiles 106, a consent module 108, a communication module 118, a user interface (UI) 120 and a database 110. The UI 120 may allow a user to interact with the family health history application 104. For example, the UI 120 may provide web 2.0 based features that allow a user to interact with the family health history application 104 via a web browser. A user may input and change information via the UI 120. For example, a user may input and/or edit a medical record profile 106 via the UI 120.

The database 110 may be used to store one or more records (e.g., medical record profiles 106) associated with a patient and/or relatives. The database 110 may be on the computing device 102 or on a remote device accessible to the computing device 102. In some configurations, the database 110 may be a central or remote database on a separate electronic or computing device. In one configuration, the database 110 is a cloud computing database. Data on the database 110 may be encrypted and/or password protected. Further, data on the database 110 may be transmitted to one or more devices using a variety of formats, such as GEDCOM (GEnealogical Data COMmunication) or HL7 (Health Level Seven International) formats. In this way, information may be shared with third parties and applications that utilize similar formats. Additionally, information may be imported from other sources and stored on a database 110 local to the computing device 102. In some configurations, data that is transmitted (e.g., imported) using GEDCOM or HL7 format may include one or more medical record profiles 106.

As stated above, the computing device 102 may include one or more medical record profiles 106. Each medical record profile 106 may include a personal profile 130. A personal profile 130 may include information about an individual, such as name, age, date of birth, date of death, ethnicity, gender, adoption status, race or other personal information that may be relevant to medical records or a medical record history associated with a patient. The personal profile 130 may also be used to identify medical records on a database 110 associated with a particular patient or individual.

The medical record profiles 106 may include diseases and conditions 132 that have been diagnosed for a particular patient. Each disease or condition 132 for an individual may be linked to the age of onset of the disease or condition 132, whether the disease or condition 132 was a cause of death, notes, information, links, etc. For example, an individual who had a stroke at age 71 and later died as a result of that stroke may have data indicating such. As another example, an individual who was diagnosed with high cholesterol at age 21 may have data indicated 21 as the age of onset. Notes linked to a disease or condition 132 may also provide relevant information regarding the disease or conditions 132.

Each medical record profile 106 may also include a health profile 134 for each individual. For example, height, weight, body mass index (BMI), physical activity, previous international travel and health habits may be included in a health profile 134. Examples of health habits may include use of tobacco, alcohol and/or drugs. Other information such as allergies and intolerances may also be included. For example, a health profile 134 may indicate that an individual is lactose intolerant and allergic to nuts and/or penicillin.

Medical record profiles 106 may also include third party record records 136. For example, data relating to test results conducted by a third party may be kept. Third party record 136 data may relate to services provided by an outside healthcare provider, test results, etc. For instance, the third party records 136 may provide results of clinical laboratory tests, a genetic condition accompanied by its DNA (deoxyribonucleic acid) sequence data, an X-ray, a Computed Tomography (CT) scan, a Magnetic Resonance Imaging (MRI) scan, a Positron Emission Tomography (PET) scan, etc. The third party records 136 may also correspond with other types of Enterprise Medical Records (EMR). Third party records 136 may also include disease or condition focused data that allows for more detailed information to be recorded. For example, if an individual tests positive for a genetic screening, a section may appear to record additional details regarding the genetic condition.

In some configurations, the computing device 102 may include a module (e.g., as part of the family health history application 104) to manage a user's participation in an early screening program with healthcare providers or public health programs. As part of the early screening management module above, an algorithm may be developed and run within the application that would look for specific data elements, like familial disease patterns, or genetic data, and suggest that the user and other family members consider genetic counseling services. The application would then allow that data be entered to track the information as visits with genetic counselors are scheduled and completed.

Each medical record profile 106 may also include relationship data 138 for an individual associated with the specific medical record profile 106. In some configurations, each individual may have relationship data 138 linking the medical record profile 106 to immediate and/or extended family members. In this manner, each individual may be linked to their immediate and extended family members. In some configurations, the relationship data 138 on the medical record profile 106 may be used to link a first medical record profile to one or more family medical record profiles stored on a database 110 of the computing device 102 or in a remote or central database on a different electronic or computing device.

In some configurations, medical record profiles 106 may be obtained and stored from other systems. For example, the user may be granted access to an external system such as an electronic medical record system from a healthcare provider or a certain permission to share data with the external system. In one configuration, as the electronic medical record system stores an identification number for the user, the application may store information on that specific system, and the ID number created by that system for the user.

The family health history application 104 may be a hardware and/or a software tool used to facilitate displaying linked family health history of a patient and/or relatives of a patient. The family health history application 104 may include a tree mapping module 122, risk analysis module 124, report module 126 and an application programmable interface (API) 128. As used herein, a “module” may be implemented in hardware, software or a combination of both. For example, each of the tree mapping module 122, risk analysis module 124, report module 126 and the API 128 may be implemented in hardware, software or a combination of hardware and software.

The tree mapping module 122 may allow a family medical tree to be expanded or collapsed. For example, the family medical tree may be expanded or contracted to show or hide in-laws, siblings, cousins, etc. Further, the tree mapping module 122 may display different views such as displaying only biological relatives, relatives affected by a certain disease, relatives who are at risk and have not been tested or screened, etc. Additionally, the tree mapping module 122 may allow a family medical tree to be redrawn based a selected individual. For example, if a child is selected, the family medical tree may be redrawn, allowing the focus to be centered on the child. In this manner, the risk analysis module 124 and the report module 126 may calculate risk levels and reports based on the child, as the new focus point.

The risk analysis module 124 may be used to determine the level of risk an individual is at for a disease or condition. The risk analysis module 124 may use information stored in individual and relative medical record profiles 106 to calculate levels of risk. For example, if a patient has a father, a grandfather and three uncles that have been diagnosed with high cholesterol around age 18, the risk analysis module 124 may use this data to calculate a level of risk that the patient will also be diagnosed with high cholesterol around age 18. The risk level may be a unit, a range, a rank, a scale, a percentage, an indication, etc. For example, the risk level may be a scale of −5 to +5, a percentage of 0-100%, an indication such as high, medium, low, etc. The risk level may be compared to a risk threshold in determining a conclusion of a risk report.

The risk analysis module 124 may also be used to determine genetic traits based on family history information. For example, if a father and a mother have both been diagnosed as each being carriers for a certain genetic mutation, then the risk analysis module 124 may determine the risk level for their child. This may assist the parents in knowing whether to test their child to confirm if the child is a carrier or if the child has the genetic mutation. The risk analysis module 124 may use family health history as well as personal health information, such as level of exercise or BMI, to calculate risk levels.

In some configurations, the risk analysis module 124 may draw on risk algorithms from a repository of risk analysis algorithms. For example, this repository may be stored in the database or another location, such as a server. The risk analysis module 124 may become increasingly accurate as more medical history data about an individual and relatives is acquired. Further, the risk analysis module 124 may provide an overall personal risk assessment based on one or more risk analysis calculations. For example, the risk analysis module 124 may estimate the age of death of a user based on one or more risk analysis calculations.

In one configuration, the risk analysis module 124 may estimate the probability of developing a disease over time for a patient or other relative based on one or more risk analysis calculations. For example, where it is known that diseases and chronic conditions such as diabetes have a family inheritance pattern, a risk algorithm may be used to predict the probability of developing diabetes based on other family members' disease experience. These risk models may be implemented using the risk analysis module 124 to identify individual family members at increased risk of the disease, target behavior that could potentially delay onset of the disease and improve health outcomes. Health calculations may also include actual genetic data of relatives (e.g., in a family health history). In one example, one or more family members may have been tested for a Mendelian disorder, involving autosomal dominate genes that are passed onto children, and spread throughout a family health history. The genetic mutations found by testing may be displayed on the pedigree. In some configurations, some family members may have been tested while other family members have not been tested. In some cases, those family members that have not been tested may be given a percentage or other value representing a predicted likelihood that they have (or may have had) a disease, and the predicted percentage or other value may be displayed as part of the family health history. In some configurations, the risk module 124 may provide a risk assessment for an individual based on a combination of actual test values as well as predicted values.

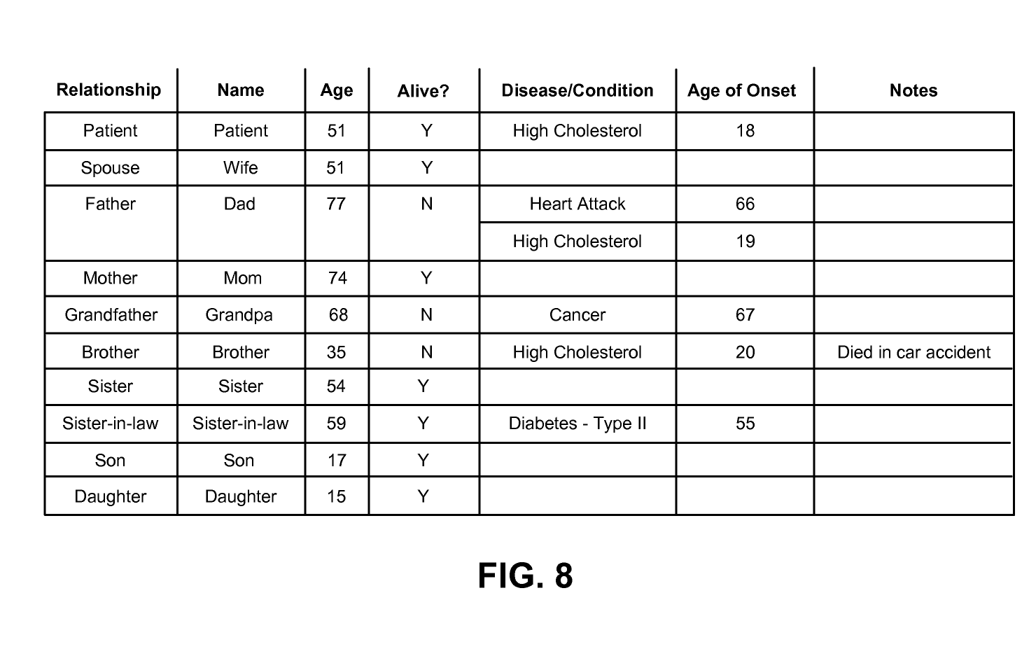

The report module 126 may be used to generate reports. A report may be focused on an individual. The report may include other family members, their relationship to the focused individual, their age, where they are living, diseases or conditions the family member has or had, age of onset, notes, etc. Examples of reports may include a disease specific report, disease category report or a total health report. A disease specific report may be a report specific to a certain type of disease, projecting a risk and/or indicating each relative in a family health history with a health history related to a specific disease. A disease category report may be more general than a disease specific report, projecting a risk and/or indicating each relative in a family health history with a health history related to a particular category of disease (e.g., heart disease, mental illness, etc.) A total health report may be more general than both a disease specific report and a disease category report, projecting a risk and/or indicating each relative and associated diseases and conditions in a family health history with a health history related to any disease or condition. One example of a health report is described in greater detail below in connection with FIG. 8. In some configurations, a report may list a summary of a patient or individual medical record profile. Further, a report may include general and/or disease-focused risk assessment reports for diseases and conditions. In some configurations, health reports may be displayed in tabular form.

The application programming interface (API) 128 may be used in conjunction with modules within the family health history application 104 as well as other third party programs and applications. For example, a third party application may use the API 128 within its application, based on level of permission or consent obtained from a patient or other individual. For instance, a commercial electronic medical record vendor may use the API 128 to have the family health history application 104 run within their system and integrate the data, or a social network may have an application that uses the API 128 based on consent (e.g., provided using the consent module 108). The API 128 may also support data load and modification from any properly permissioned and authenticated source. This may allow data to be inserted by other third party tools or by other sources of family health history. For example, the user may choose to use a drug management application, or an exercise application, and give permission to have data shared between these applications and the main family health history application 104. The API 128 may also support queries against the database 110. Thus, data may be extracted for use by a variety of back end applications like health care record systems or research systems. These back end query customers may be charged depending on the types of queries that are run, including the breadth and depth of data that is accessed and the amount of access that is provided to the sources of that data.

The consent module 108 may be used to authorize and monitor consent and privacy settings. The consent module 108 may include a consent engine 142 and one or more consent records 140. The consent module 108 may use a consent engine 142 to create, manage, modify and/or revoke consent records 140. The consent engine 142 may perform the authorization verifications before access is granted. The consent engine 142 may allow certain groups to view family health history data while allowing other group members the ability to modify and/or update portions of the family health history data, all while tracking the original source of the data along with an editing history. For example, the consent engine 142 may allow a health provider to report test results in an individual medical record profiles 106.

Consent records 140 may be created to authorize consent to at least a portion of a family health history. For example, one consent record 140 may grant full access of the family health history to a healthcare provider. As another example, a consent record 140 may grant third parties access to a particular disease or condition in the family of a patient. For instance, the consent record 140 may allow use of only relevant portions of a particular family's medical data to determine if a patient, relative or other individual is a candidate for a medical trial. In this case, the consent record 140 may protect other non-relevant information such that the identities associate with a medical record profile may remain anonymous.

In another configuration, the consent engine 142 may alter personal information to keep the user and user's family members anonymous. For example, the consent engine 142 may generalize family names to be “father,” “mother,” “son,” “daughter,” “maternal grandmother,” etc. Additionally, the consent engine 142 may exclude certain diseases or conditions from one or more individuals, such as individuals who are still living.

A consent record 140 may allow relatives within a family health history to access the family health history. In some configurations, the consent record 140 may require a password before others are granted access. In some configurations, other types of verification checks may be used to verify a family member's identity and relationship. For example, the consent module 108 may require that both family members confirm their relationship with each other before an authorization is recorded on a consent record 140.

In some configurations, when sharing a family health history between family members, the consent engine 142 may only allow common relatives to be shared and/or displayed. As an example, if a patient shares her family health history with a cousin on her father's side, the consent engine 142 may prevent family information pertaining to the user's mother's side to be shared with the cousin. In this manner, common family members may be displayed showing relevant family medical information while keeping non-common relatives private and protected.

The group participation selection module 112 may enable selection of one or more groups or individuals to access an individual medical record profile 106 and/or related profiles associated with the individual medical record profile 106. The group participation selection module 112 may specify groups such as healthcare providers 144, disease associations 146, research study groups 148, family members and other third party groups 150. For example, a healthcare provider 144 may include hospitals, clinics, doctors, healthcare systems, insurance companies or other individuals and groups that provide health care services. Disease associations 146 may include entities associated with diseases and conditions such as genetic mutations, lung cancer, diabetes, Parkinson's disease, etc. Research study groups 148 may include pharmaceutical and biotechnology companies, clinical trials, academic research, national medical research institutions, governmental research institutions, state departments of health, etc. Family members may include immediate family members as well as more distant relatives. Family members may also be separated into ancestors, descendants, siblings, etc. In some configurations, the family health history application 104 may contain educational content, or link to external content, related to family health history, genetics and general medicine.

Third party groups 150 may include remote storage databases, such as Microsoft© HealthVault, employer personal health record (PHR), health plan PHR, genealogical sites, etc. In some configurations, third party groups 150 may include social networks. In this manner, a family health history may be publicly shared between family members. Family members can be invited to update family health history. Here, the consent engine 142 may grant full access to one group and partial access or limited access to another group. The consent engine 142 may even alter information, such as names, dates and locations, for other groups for privacy reasons. The consent engine 142 may also provide functionality to track, moderate and/or alert family members about conflicting information entered by different individuals.

The group participation selection module 112 may allow a computing device 102 to grant permissions to an entire group or only select members of a group. The group participation selection module 112 may also prompt an individual to grant permission to a requesting entity. For example, entities may be able to gain access to generic information regarding target groups of individuals with particular diseases or conditions. Based on privacy and consent settings associated with associated medical record profiles 106, the requesting entity may prompt a user for partial or full access to the user's family health history. In some cases, this request may be made via the communication module 118.

The communication module 118 may facilitate the sending and receiving of messages and/or other communications. The communication module 118 may include messages 152. Messages 152 may be sent and received by one or more individuals, healthcare providers, third parties and/or the family health history application. For example, an individual may send a message 152 to a parent requesting they get screened for a genetic mutation. The communication module 118 may show the user that the message 152 has been sent to the parent. When a reply message is received, the communication module 152 may show the user the reply message. For example, the parent may reply that they have an appointment to be tested. Once the parent has completed the test, the communication module 118 may inform the child of the completed test. In some instances, the test results may be sent to the user, automatically updating the parent's individual medical record profile 106. This updated information may then cause the risk analysis module 124 to automatically recalculate a risk level of the user for the disease or condition 132.

As another example, a health care provider may use the communication module 118 to inform a user of appointments, test results, questions, answers, prescriptions, claims, etc. Further, the family health history application 104 may send messages to inform a patient as to relevant information (e.g., permissions or consent) pertaining to the patient's medical record profile 106. For instance, a message 152 may inform a user that data has been shared with a relative or that an error has occurred.

Additionally, third parties may use the communication module 118 to communicate with a computing device 102 and/or other remote device. For example, a third party may invite a patient to participate in a study. Messages from third parties, relatives, doctors, healthcare providers, etc. may be conditional upon consent given by the patient. The patient may consent to sending a subset of their family health history to the third party or health care provider.

In some configurations, the communication module 118 may use an audio exchange module (such as a Siri-type feature) to receive and provide information. For example, answers would be limited to data and information in the application. For example, after selecting the button to call the Siri-like feature, the user may ask to find if a specific relative had entered a message in a specific community. The Siri-like feature may answer yes and takes the user to the specific community and present the message from the relative.

In one configuration, the computing device 102 may be used to create a medical record profile 106 for a patient. The computing device 102 may store the medical record profile 106 in the database 110 on the computing device 102 or on a separate database from the computing device 102. The computing device 102 may compare the patient medical record profile 106 with one or more medical record profiles 106 stored on the database 110 or received from a third party source and determine one or more related medical record profiles 106 to the medical record profile 106 of the patient. Determining relationships may be performed by comparing relationship data obtained from a patient and relationship data on other medical record profiles 106. The computing device 102 may then establish a family link between the medical record profile 106 of the patient and any number of related medical record profiles 106.

Linking the medical record profiles 106 to create a family health history may include obtaining consent from a patient and/or one or more relatives to link and/or access medical records of the related medical record profiles 106. As explained above, obtaining consent may include various methods, such as obtaining consent of a patient, obtaining consent of a related party, or obtaining consent from a third party source, such as an insurance company, a health care organization or other entity with knowledge or data associated with medical record profiles 106. In some configurations, all that is needed is a consent from a particular patient, who may add details to one or more related medical record profiles 106 based on personal knowledge, official records, or other source of medical record data. Further, access to particular information within a medical record profile 106 may be completely restricted, partially restricted or granted without restriction based on varying levels of consent or permission, allowing access to certain health information without necessarily granting total access to the medical record profile 106 of a particular individual or relative. Thus, the computing device 102 may generate a family health history so far as consent is given for the patient and/or related medical record profiles 106.

The computing device 102 may further display the family health history based on medical record profiles 106 of a patient and relatives. The display of the family health history may show the hierarchy of a family tree and relationships between a patient and related individuals. Each individual may be represented by displaying a respective medical record profile 106, including some or all of the data within the medical record profile 106 on the family health history display. For example, the display may show icons and/or other indicators to illustrate a personal profile 130, medical conditions and diseases 132, health profiles 134 and other information associated with each medical record profile 106 that is displayed. Further, even where permission is not granted for a particular medical record profile 106, the family health history may still display a partial profile for an individual, without also displaying additional data that would be included within a medical record profile 106 of that individual. In some configurations, the family health history display may include an interface that permits linking, editing, deleting, writing and performing other functions on each medical record profile 106 that is displayed. Further, the amount of information displayed, as well as the ability to link, edit, delete, write and/or interface with the displayed data may be based on a level of consent or permission granted to a patient, health care provider or other individual associated with the computing device 102.

The medical record profiles 106, including the display of the family health history may be shared with one or more entities. For example, the group participation selection module 112 may be used to determine one or more groups, such as a health care provider 144, disease association 146, research study group 148 or other third party group 150 that may link and/or access one or more medical record profiles 106 within a health family history. Sharing this information with other groups or individuals may be facilitated by granting access to the database 110 and/or exporting health history information using a particular format (e.g., GEDCOM or HL7). Thus, health history information may be easily shared over a variety of platforms, including health exchanges or social networking platforms.

The computing device 102 may use a variety of methods and configurations in implementing various features and applications of creating, displaying, modifying and sharing the family health history. In one configuration, a computing device may restrict access to a family health history based on a subscription status (e.g., a paid for subscription). Alternatively, the family health history may be publicly shared, such that any relative or individual may access a medical record profile 106 on the database. In some configuration, the family health history may be updated using social networking-type features where health information may be obtained from a social networking platform and/or linked directly to social networking accounts (e.g., Facebook, Ancestry.com). In cases where multiple entities may add or modify health information, the computing device 102 may include mechanisms for verifying information and tracking, moderating or alerting family members about conflicting information. For example, the family health history application 104 may log the source of some or all information that is entered by a user, relative, or information that originates from an external source system. The family health history application 104 may also flag data as being reviewed and validated by a medical doctor. In one configuration, the user may select from the multiple sources of data, that may be conflicting, which source they want the family health history application 104 to use. For example, if the user enters that a relative died of lung cancer, but another relative reports that the relative died of throat cancer, the user can see both entries and select which data they want the application to use, for example, in generating a risk report.

Although not shown in FIG. 1, the family health history application 104 may also include a module that allows users to create and participate in online communities with other users. When creating and defining the specific of a new community, the user can choose the subject, what other users can join, and how the community will communicate with the participating community members. This module (e.g., community module) may also give the user the ability to search for other existing communities, request to join existing communities and add to and receive messages within that community.

These communities may include user relatives or others that are not related to a user. Subjects of the communities may be created by users. For example, a user may create a community that discusses a specific disease or medical condition that participants may share in common. Another community may be created to share specific medical therapies the group has in common and share effectiveness of those therapies.

The family health history application 104 may also implement “to do” and reminder lists. For example, if the user thinks of questions they want to ask a family member, doctor, or researcher, they can use the question list manager. They may also manage “to do's.” For example, a user may make a medical appointment, fill a prescription, or complete a task on the application. The reminder list would trigger the user to complete items on the question and/or “to do” lists.

The family health history application 104 may include, or link to, a personal health survey module. While not shown in FIG. 1, the personal health survey module may be a comprehensive survey tool focused on a patient, beyond the family health history summary of relatives, which may be included within the family health history application 104. Diseases or medical information entered by the user in the personal health survey module may be used by the family health history module and shared with relatives, depending on user consent. For example, a relative may complete the personal health survey and record diabetes as part their medical history. When the relative consents to share, the diabetes information will become part of the user's family health history and used in risk assessment calculations. When using the personal health status module, if a user has a question that is not personally known, a reminder to gather that information may be automatically recorded on the a user reminder list.

While not shown in FIG. 1, the family health history application 104 may also include a reward program manager module. This reward program would encourage the user to contribute significant content that is crucial to the value of the application, for both the user and relatives. For example, users may get reward points for completing a pedigree, inviting relatives to join, or creating communities. Users may also receive reward points for suggesting new application features. The reward points may be redeemable for products and services offered by the host of the application, by sponsors of the application, for example, a healthcare system, a health plan, or a public health program, and advertisers on the application.

While not shown in FIG. 1, the family health history application 104 may also include a module to import and store genetic data, or link to an external genetic data source. For example, the computing device 102 may use a direct-to-consumer genetic testing service like 23and Me. The user may select an application option to import the data file created be 23and Me, and the data may become available to the application, sharing the data depending on user consent.

In some configurations, the family health history application 104 may have the ability to link to and consume data from biosensors. A biosensor is an electronic device, usually worn by a person, that records live medical readings of the person. For example, a person with a family history of heart disease may wear a biosensor that tracks heart rhythms. The application may collect the data, display the data and, with user consent, share the data with relatives that may have the same familial risk.

In some configurations, the family health history application 104 may present to the user phenotypic surveys. A phenotypic survey may ask about physical manifestations of diseases or medical conditions in a person. For example, a survey may appear in the application that asks the user the frequency they acquire the common cold. Survey data can be displayed for the user, shared with relatives, and used for research applications, if consented by the user.

In some configurations, the family health history application 104 may present to the user surveys on the effectiveness of drug and other therapies. For example, a survey may appear in the application that asks the user if a certain drug causes side effects, like nausea. Survey data can be displayed for the user, shared with relatives, and used for research applications, if consented by the user.

While not shown in FIG. 1, the family health history application 104 may also include a module that helps the user perform comparison shopping for healthcare services. For example, the application may display publically available data on office visit charges by a doctor, room charges by a hospital, or costs differences between brand and generic drugs. This information may be collected by both the application and the user, and shared with relatives, or in communities. The application may contain the ability to track medical spending cost savings and improved health outcomes. For example, if the user follows a complete drug regimen, the user may save money on more avoidable care, and be healed quicker.

While not shown in FIG. 1, the family health history application 104 may also include an advertising module. The advertising module may allow for data mining that targets specific advertising to users. For example, a survey that performs a deeper assessment of a user's coronary heart disease risk is brought to you by a cholesterol drug company.

The family health history application 104 may also include additional modules and features. For example, the family health history application 104 may include a module to handle user transactions for purchases of products and services available from the application. Further, the family health history application 104 may be used by researchers and clinical trials to allow customers to query the entire population of the database 110 on certain criteria. Data may be returned as stats aggregate and may contain no personal information. If the numbers returned indicate a population interest of customers in the database 110, the customer may request more detailed data (e.g., at an additional cost). If a customer (e.g., researcher or clinical trial entity) desires contact with specific users in an identified target population, the host application may mediate communication and consent between the customer and user represented in the database, for example, to contact and gauge interest in participating in a clinical trial and other research. In some configurations, the family health history application 104 may allow the sponsoring health providers to include information on how to get services from that provider. For example, the application may have an “Our Services” section to include information about the sponsoring provider. In some configurations, the family health history application 104 may include both web-based and mobile applications.

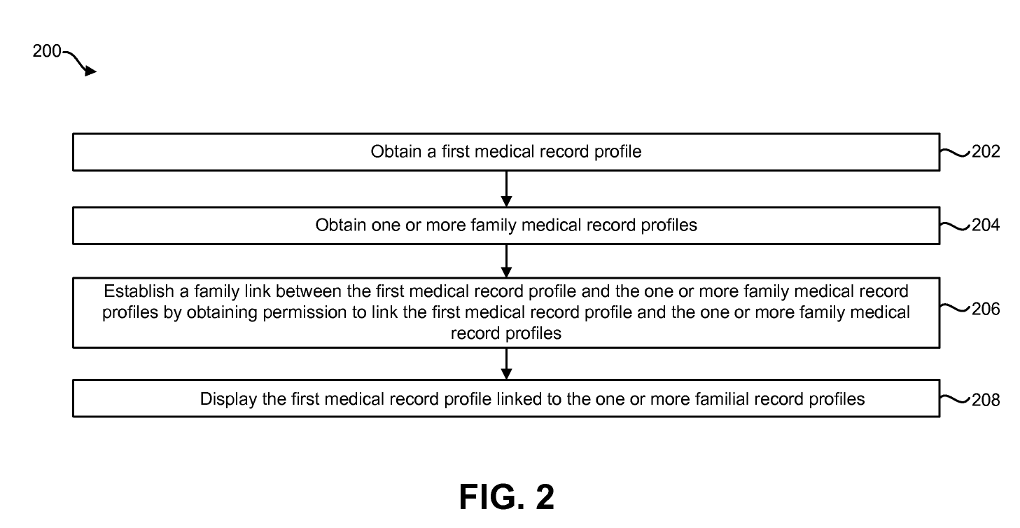

FIG. 2 is a flow diagram illustrating one configuration of a method 200 for displaying linked family health history. The method 200 may be performed by a computing device 102 (e.g., electronic device, server, smart phone, etc.)

A computing device 102 may obtain 202 a first medical record profile. The first medical record profile may be one example of an individual medical record profile 106 described above in connection with FIG. 1. The first medical record profile may be obtained from a database 110 stored on the computing device 102 or from a central or remote database. The first medical record profile may also be obtained via importing the first medical record profile from a third party source and/or via a third party platform (e.g., social networking platform).

The computing device 102 may obtain 204 one or more family medical record profiles. Each of the family medical record profiles may be related to the first medical record profile. In one configuration, the computing device 102 may obtain all accessible family medical record profiles with common relationship data to the first medical record profile. In some configurations, rather than collecting all family medical record profiles, the computing device 102 may obtain any family medical record profiles within three generations of the first medical record profile.

The computing device 102 may establish 206 a family link between the first medical record profile and the one or more family medical record profiles. Establishing a family link may include obtaining permission to link the first medical record profile and the one or more family medical record profiles (e.g., using the consent module 108) Establishing 206 the family link may include obtaining permission to access one or more records on a first medical record profile and/or obtaining permission to access one or more records on each of the one or more family medical record profiles. Obtaining permission to access one or more medical record profiles 106 may include receiving permission via a permission request to a patient associated with the first medical record profile and/or receiving permission via a permission request to relatives to a patient associated with respective family medical record profiles.

Obtaining permission to link and/or access one or more medical record profiles 106 may vary in the level of permission granted or the number of medical record profiles 106 for which permission is sought. In some configurations, one or more medical record profiles 106 are publicly accessible, thus requiring no permission, or only permission of a patient, to access medical record profiles 106 of related persons. Permission to access medical profiles may also be limited in the data that is accessible from each medical record profiles 106. For example, permission may be obtained to access only the diseases and conditions 132 and the health profile 134 of a particular medical record profile 106 without also obtaining access to the personal profile 130 or other data within the medical record profile 106. Thus, it may be possible to obtain access to only the relevant health information within a medical record profile 106 while maintaining anonymity of a patient and/or relatives. Obtaining permission to link and/or access medical record profiles 106 may also be limited to those patients, relatives or organizations that have granted access to a patient, health care provider or other individual or organization to access certain records. In some configurations, permissions may be obtained upon creation of a medical record profile 106 or at any point before generating a family health history. Further, where certain permissions are not obtained beforehand, obtaining permission to link or access medical record profiles 106 may be obtained via a request for permission from a patient, relative, healthcare provider, database server or other entity that controls access to one or more medical record profiles 106.

The computing device 102 may also display 208 the first medical record profile linked to the one the more family medical record profiles. The first medical record profile and family medical record profiles may be linked according to relationship data 138 within respective medical record profiles 106. For example, the medical record profiles 106 may be in a family tree configuration to illustrate family relationships between a patient associated with the first medical record profile and individuals associated with each of the family medical record profiles. Displaying 208 the medical record profiles 106 may also include displaying one or more icons to indicate various personal profile information 130, diseases and conditions 132, health profiles 134 and other information included within the respective medical record profiles 106. The computing device 102 may also display a risk level associated with a particular disease or condition via an icon or other visual indication of the risk level. The display of the medical record profiles may be part of an interface (e.g., UI 120), enabling a patient, health professional or other individual to read, write or edit one or more medical record profiles 106 that are displayed. Thus, individual medical record profiles 106 may be created, modified or deleted by interfacing with the family health history display.

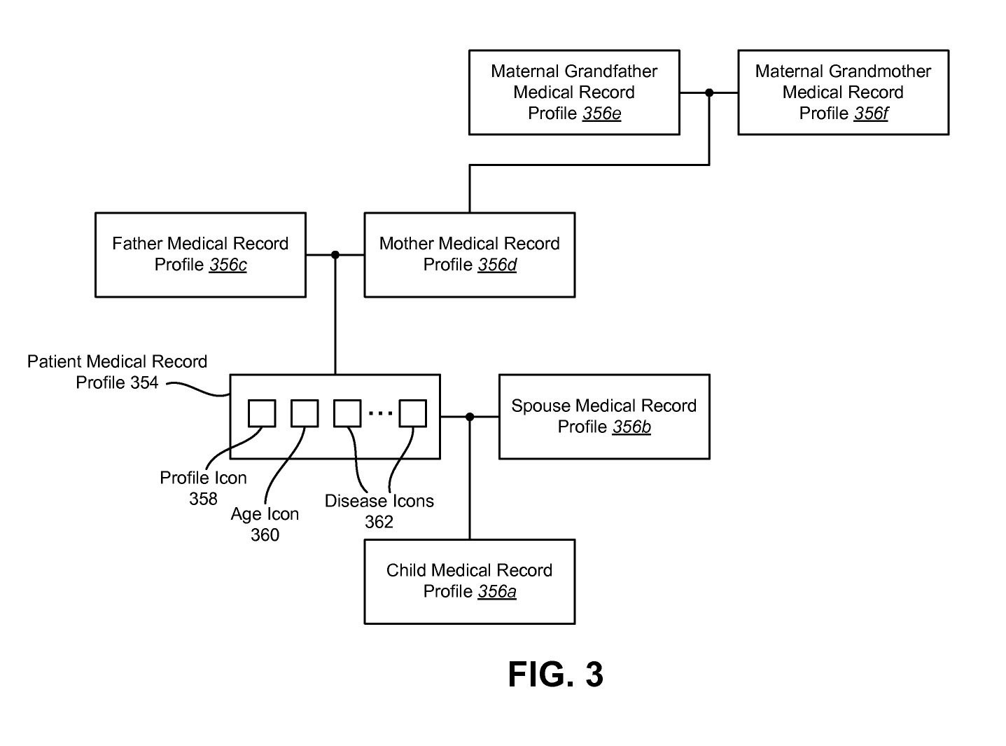

FIG. 3 is a block diagram illustrating one configuration of a linked family health history display. In FIG. 3, seven individual medical record profiles 354, 346a-f corresponding to seven individuals are displayed. The patient medical record profile 354 may include a display of various icons, such as a profile icon 358, age icon 360 and one or more disease icons 362. Each of the displayed family medical record profiles 156a-f may include similar icons. Further, each of the medical record profiles 354, 356a-f may include a display of additional information, such as a name, age, gender, relationship, diseases and conditions, age of onset, mortality status, one or more health habits or other information included within the medical record profile. For example, although not shown in FIG. 3, the profile indicated as maternal grandfather medical record profile 356e may include an indication of death at age 89 from kidney failure.

Any one of the medical record profiles may be the center or focus of the family health history display. For the sake of simplicity, the configuration the display in FIG. 3 illustrates a family health history display focused on a patient medical record profile 354. In the illustrated example, the family health history also includes a child medical record profile 356a, a spouse medical record profile 356b, a father medical record profile 356c, a mother medical record profile 356d, a maternal grandfather medical record profile 356e and a maternal grandmother medical record profile 356f. The family health history display may be provided as an interface by which additional medical record profiles may be added, created, modified and/or deleted. Thus, by displaying the family health history using a visual relationship hierarchy, medical record profiles may be easily added, created, modified and/or deleted with ease. In some configurations, selecting another medical record profile may cause the family health history display to be redrawn using a new medical record profile as the focus of the display. For example, the spouse medical record profile 356b may be selected to create a new family health history display to add additional medical record profiles or to reveal a different portion of relevant medical record profiles, based on genetic relationships of a spouse of a patient.

In some configurations, the computing device 102 may display only a portion of the family health history based on a selected disease or disease type. For example, where a patient is only interested in viewing individuals in a family health history with a history of heart disease, the computing device 102 may provide a display of only those individuals in the family health history with a history of heart disease by selecting a heart disease icon or other displayed option. Other types of restrictions, such as generational restrictions and/or disease or condition restrictions may also be applied when generating the family health history display.

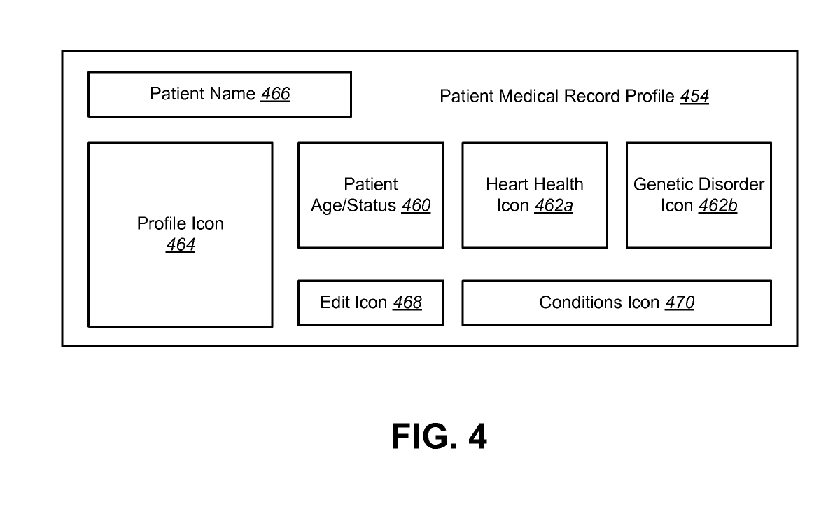

FIG. 4 is a block diagram illustrating one configuration of a patient medical record profile display. The patient medical record profile 454 may be one configuration of a display of any individual medical record profile 106 described above in FIGS. 1-3. The profile display may be a simplified or condensed version of a medical record profile 106 when shown linked to one or more additional medical record profiles 106. FIG. 4 illustrates one example of a medical record profile 106 as it may be displayed within the family health history display.

In one configuration, the patient medical record profile 454 may include a display of a patient name 466, a profile icon 464, a patient age/status 460 (e.g., mortality status), as well as one or more disease icons 462. For example, the patient medical record profile 454 may include a health heart icon 462a and a genetic disorder icon 462b. Each of the disease icons 462 may represent a specific disease or a category of diseases. Examples of categories of diseases or conditions that may be represented using disease icons 462 may include allergy/atopic disease, birth defects/anomalies, blood and clotting, cancer, dental, endocrine/fertility, eyes, gastrointestinal/liver, genetic disorders, heart and blood vessels, joints and rheumatic, kidney, lung/respiratory, neurologic/brain, psychiatric and skin/hair diseases and/or conditions.

The patient medical record profile 454 may also include a conditions icon 470, which may display a list of conditions of the patient and/or relatives. The condition icon 470 may also be selected to obtain a more detailed version of the patient medical record profile 454 in order to see a more detailed explanation of the diseases and conditions or to view additional information (e.g., personal profile information and/or health profile information) about a patient. The patient medical record profile 454 may also include an edit icon 468. Selecting the edit icon 468 may enable the computing device 102 to modify the patient medical record profile 454 and related medical record profiles 106 via the family health history display.

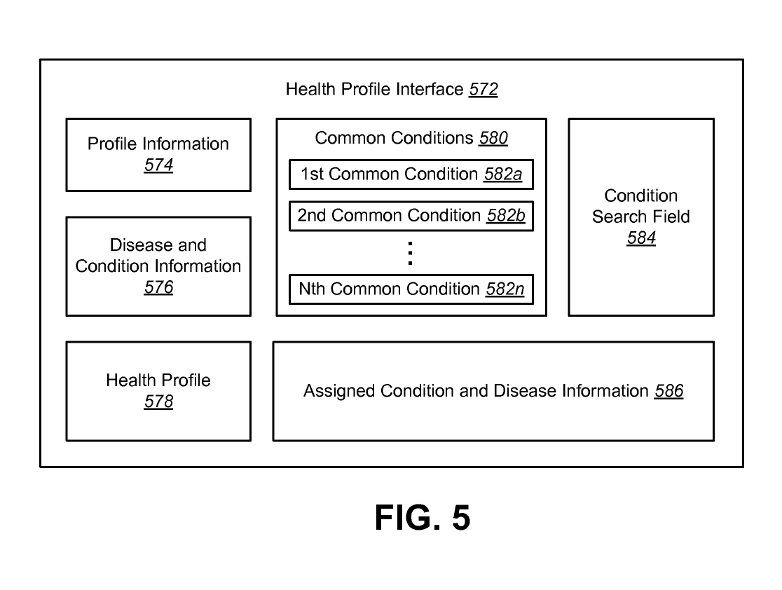

FIG. 5 is a block diagram illustrating one configuration of a health profile interface 572. The health profile interface 572 may be displayed upon selecting a medical record profile 106 that is displayed in the health history display. For example, the health profile interface 572 may be displayed upon selecting a conditions or editing icon on a displayed medical record profile 106. The health profile interface 572 may display a more detailed version of the medical record profile 106 and provide an interface by which a medical record profile 106 may be created, edited or otherwise modified. The health profile interface 572 may include various fields displaying data from within the medical record profile 106. Each medical record profile 106 may be associated with a respective health profile interface 572. Thus, any references herein to a health profile interface 572 of a patient may be generally applied to other medical record profiles 106 (e.g., family medical record profiles).

In one configuration, the health profile interface 572 may include fields that display profile information 574, disease and condition information 576 and a health profile 578. The health profile interface 572 may also include a display of a list of common conditions 580, including a first common condition 582a, a second common condition 582b and any number of common conditions 582a-n that may be associated with a medical record profile 106. In one configuration, the list of common conditions 580 may include selectable icons that correspond with a list of common diseases or conditions that a patient may have previously experienced or that the patient currently experiences. The selectable icons may correspond to specific conditions or condition categories, such as Alzheimer's disease, arthritis, asthma, breast cancer, colon cancer, depression, diabetes, glaucoma, heart attack, high cholesterol, hypertension, kidney disease, osteoporosis, ovarian cancer or stroke. Upon displaying the health profile interface 572, an input device 114 may be used to modify the corresponding medical record profile 106 by selecting or deselecting one or more common conditions 582a-n.

The health profile interface 572 may also include a condition search field 584. The condition search field 584 may include a searchable list of conditions and diseases that may have been diagnosed for a patient or other individual. In cases where a disease or condition is not found in the display of common conditions 580, but has still been diagnosed or known to have been diagnosed for a particular patient, a disease or condition in the condition search field 584 may be selected and added to the medical record profile 106.

The health profile interface 572 may also include a field that displayed assigned condition and disease information 586. The assigned condition and disease information 586 may include additional details about any diseases or conditions associated with a particular patient. For example, the assigned condition and disease information 586 may include a list of each disease or disease category that has been selected for a particular profile, as well as the age of onset and whether that disease or condition is the cause of death for a patient or other individual. Additionally, the assigned condition and disease information 586 may include a display of various icons that may permit generating or retrieving a report (e.g., a risk report) or obtaining additional information about that particular disease, such as family members who have been diagnosed with similar diseases or categories of disease, or icons that may be used for editing or deleting information from the assigned conditions and disease information 586. Thus, the health profile interface 572 may provide a detailed display of individual health information and a method for modifying health information in a particular medical record profile 106 of a patient or other individual.

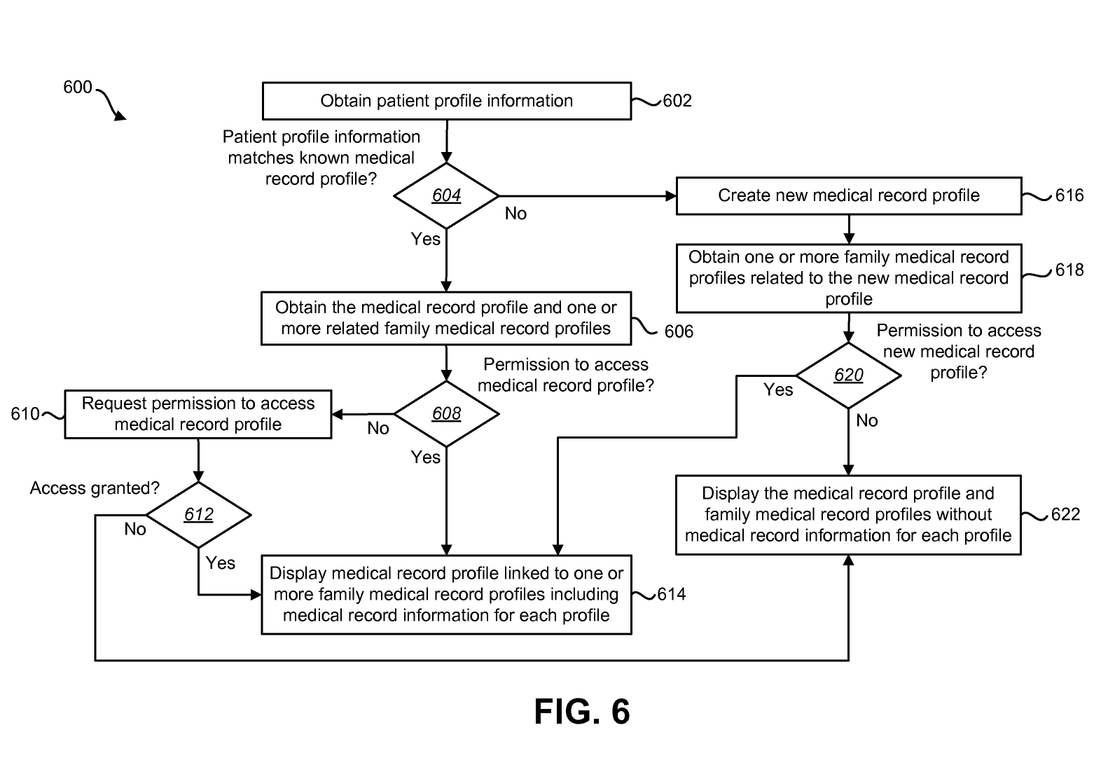

FIG. 6 is a flow diagram illustrating a more detailed configuration of a method 600 for displaying linked family health history. The method 600 may be performed by a computing device 102 (e.g., electronic device, server, smart phone, etc.)

A computing device 102 may obtain 602 patient profile information. Obtaining 602 patient profile information may include obtaining personal information, such as demographic information, about a patient that is seeking health care and/or enrolling in a health coverage database. The computing device 102 may determine 604 whether the patient profile information matches a known medical record profile 106 (e.g., stored on a database or a remote device). For example, where a patient has previously enrolled in a database 110 of medical record profiles 106, the patient profile information may be used to identify a medical record profile 106 for the patient that has already been created (e.g., by the patient at a previous date or by a third party when generating a related family health history).

If the patient profile information does not match any medical record profiles, the computing device 102 may create 616 a new medical record profile. Creating 616 a new medical record profile may include obtaining permission to receive a medical record profile 106 for the patient from a third party and/or obtaining information directly from a patient. Other methods of obtaining permissions for medical record profiles may also be used (e.g., public profiles, social networking platforms, etc.). The computing device 102 may also obtain 618 one or more family medical record profiles related to the new medical record profile. The related family medical record profiles may be obtained similarly to obtaining a medical record profile of a patient. The computing device 102 may determine 620 whether the computing device 102 is permitted to access the new medical record profile and/or related medical record profiles. If the computing device 102 receives permission to access the new medical record, the computing device 102 may display 614 the medical record profile linked to one or more family medical record profiles, including medical record information for each profile (e.g., displayed in the family health history). Conversely, if the computing device 102 does not receive permission to access the new medical record profile, the computing device 102 may display 622 the medical record profile linked to one or more family medical record profiles without medical records for each profile.

In some configurations, the computing device 102 may display a combination of medical record profiles including medical records for which permission has been obtained and medical record profiles without medical records for which permission has not been obtained. For example, where permission has been obtained to access certain records of medical record profiles, those specific medical record profiles for which permission has been granted may be displayed within a family health history including health records for each of the profiles. In contrast, where permission has not been obtained to access certain medical record profiles within a family health history, those medical record profiles may still be displayed within the same family health hierarchy without also displaying any medical records or other details within the medical record profiles for which permission has not been obtained. Thus, a family health history display may include a combination of medical record profiles 106 that are displayed with medical record information and medical record profiles 106 that are displayed without medical record information.

If the computing device 102 determines 604 that the patient profile information matches a medical record profile, the computing device 102 may obtain 606 the medical record profile and one or more related family medical record profiles. Obtaining 606 the medical record profiles may include obtaining the profiles from a database 110 on the computing device 102 or obtaining the medical record profiles from a remote database, central database, third party entity or other source. The computing device 102 may also determine 608 whether permission to access one or more medical record profiles has been granted. If permission has been granted, the computing device 102 may display 614 the medical record profile linked to one or more family medical record profiles including medical records for reach profile. As stated above, the computing device 102 may display any of the medical record profiles including medical record information for the medical record profiles for which permission has been obtained.

If the computing device 102 has not obtained permission to access the medical records, the computing device 102 may request 610 permission to access the medical record profile. Requesting 610 permission may be directed at a patient and/or any individuals associated with certain medical record profiles. The computing device 102 may determine 612 if access has been granted (e.g., based on a response to the request). If access is granted in response to the request, the computing device 102 may display 614 the medical record profile linked to one or more family medical record profiles including medical record information for each profile. If access is not granted, the computing device 102 may display 622 the medical record profile linked to one or more family medical record profiles without medical record information for each profile.

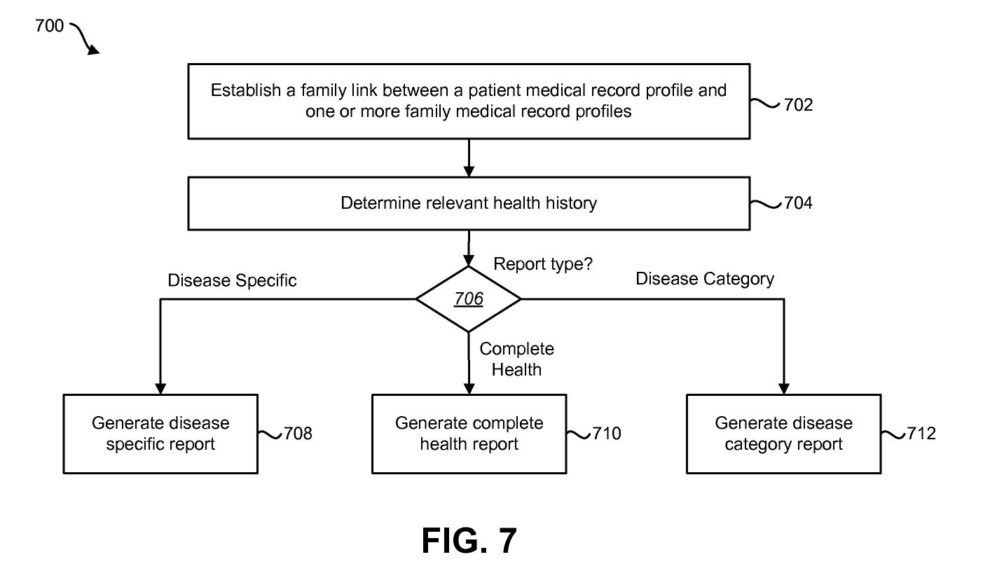

FIG. 7 is a flow diagram illustrating one configuration of a method 700 for generating a health report based on a family health history. The method 700 may be performed by a computing device 102 (e.g., electronic device, server, smart phone, etc.).

A computing device 102 may establish 702 a family link between a patient medical record profile and one or more family medical record profiles. Establishing 702 a family link may be one configuration of establishing 206 a family link described above in connection with FIG. 2. Further, establishing 702 a family link may include obtaining permission to access and/or link the medical record profiles.

The computing device 102 may determine 704 relevant health history. Determining 704 relevant health history may include determining consanguinity and/or proximity of one or more relatives that may have experienced a certain disease or condition. For example, if a relative has been adopted, and therefore have no consanguinity with a patient, any diseases or conditions of that relative may be discarded when determining 704 a relevant health history. Further, where a relative is more than three generations removed from a patient, any risk associated with a particular disease or condition may be minimal as compared to a closer relative such as a parent or grandparent. Relevant health history may also be based on future generations, such as children or grandchildren, where a condition or disease in a child or grandchild may prompt a notification or alert that a patient might be at risk for a certain disease or condition for which they have not been diagnosed. In one configuration, the health profile of a relative may be considered in determining the relevancy of a particular disease. For example, where a relative suffers from asthma or lung cancer, but whose health profile indicates a history of smoking, risks associated with these diseases may be affected when generating a risk report and/or calculating a risk associated with a specific disease or disease type.

The computing device 102 may determine 706 what report type to generate. For example, a risk report may be generated based on a specific disease, a disease category or the complete health of a patient based on the relevant health history. If the report type is disease specific, the computing device 102 may generate a disease specific report 708. If the report type is complete health, the computing device 102 may generate 710 a complete health report. If the report type is disease category, the computing device 102 may generate 712 a disease category report. Each of the reports may vary in the breadth of information considered when determining a risk and/or generating a risk report for a patient.

The report may represent a risk associated with a particular disease, disease type or total health in general based on a family health history. A risk report may be a percentage, number or other value that represents a level of risk associated with a particular disease or condition. In some configurations, the risk may compare to a threshold which, if exceeded, may generate a trigger alert or automatically produce a report that indicates a need or a recommendation to be tested for a particular disease or condition. In some configurations, the risk report may recommend that a relative, such as a descendent or other relative, be tested for a disease or condition that runs in the family. Any risk values may be calculated using, for example, a risk analysis module 124, and use a variety of algorithms when determining the risk of a particular patient.

In one configuration, a risk value for a patient may be generated based on only those relatives that have been diagnosed with a particular disease or condition, and not considering those relatives who have not been tested and/or diagnosed. In another configuration, the computing device 102 may determine risks associated with all relatives that have not been tested and/or diagnosed, and then generate a risk value for a patient based on a combination of actual diagnoses as well as the generated risk values for those relatives who have not been tested or diagnosed. These risk values may be updated as more information (e.g., diagnoses and tests) becomes available. In cases that risk values are changed based on updated information, the computing device may provide an alert (e.g., a risk change alert) if the updated information would change a risk value above a certain threshold.

FIG. 8 is table illustrating one configuration of a health history report based on a family health history. As with FIG. 3, for the sake of simplicity, an individual referred to as “Patient” is the focus point of the family health history report. In other words, each relationship is based on relationship of “Patient” with other individuals. It is also noted that this table is one configuration of a table that may be generated as part of a total health report, which is not specific to any particular disease or disease category. Nevertheless, similar tables may be generated based on disease specific or disease category reports.

The table may provide a summary view of a user's family health history. The table may include columns representing relationship, name, age, mortality status, disease/condition, age of onset and notes. The age may represent the age of the individual who is currently living or the age of the individual at their death. The notes section may provide relevant medical information. For example, the notes show that brother died of a car accident rather than from a medical condition such as high cholesterol.

The family health history summary report may allow recognition of different trends. For example, if Patient, Father and Brother were diagnosed with high cholesterol at ages 18-20, Son may want to get tested and/or monitor his cholesterol levels. The computing device 102 may indicate this recommendation in the report. In this manner, the family health history report summary can provide valuable information to an individual pertaining to current and future health based on family health history. Further, a computing device 102 may provide the report, or a subset or the report, to a healthcare provider or a third party. Additionally, the computing device 102 may create a consent record that allows a certain level of access to the family health history summary report. In some configurations, conclusions from the summary report may be added to a medical record profile 106.

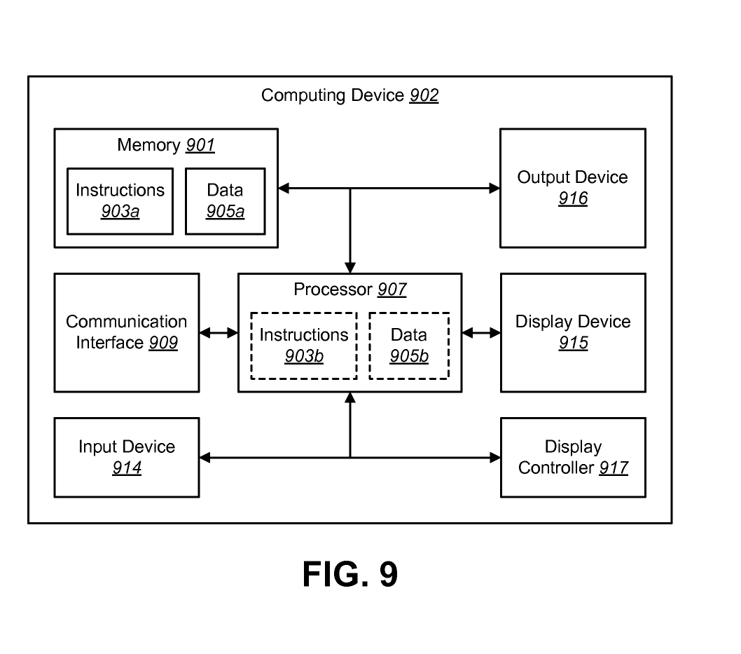

FIG. 9 illustrates various components of a computing device 902 that may be utilized for synoptic element structured reporting. The computing device 902 illustrated in FIG. 9 may be configured similar to the computing device 102 illustrated in FIG. 1. The illustrated components may be located within the same physical structure or in separate housings or structures.

The computing device 902 may include a processor 907 and memory 901. The processor 907 controls the operation of the computing device 902 and may be implemented as a microprocessor, a microcontroller, a digital signal processor (DSP) or other device known in the art. The memory 901 may include instructions 903a and data 905a. The processor 907 typically performs logical and arithmetic operations based on program instructions 903b and data 905b stored within the memory 901. That is, instructions 903b and data 905b may be stored and/or run on the processor 907.

The computing device 902 typically may include one or more communication interfaces 909 for communicating with other electronic devices. The communication interfaces 909 may be based on wired communication technology, wireless communication technology, or both. Examples of different types of communication interfaces 909 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computing device 902 typically may include one or more input devices 914 and one or more output devices 916. As stated above, examples of different kinds of input devices 914 include a keyboard, mouse, microphone, remote control device, button, joystick, trackball, touchpad, lightpen, etc. Examples of different kinds of output devices 916 include a speaker, printer, etc.

One specific type of output device 916 that may be typically included in a computer system is a display device 915. Display devices 915 used with configurations disclosed herein may utilize any suitable image projection technology, such as liquid crystal display (LCD), light-emitting diode (LED), gas plasma, electroluminescence, a cathode ray tube (CRT), or the like. A display controller 917 may also be provided for converting data 905a stored in the memory 901 into text, graphics, and/or moving images (as appropriate) shown on the display device 915.

FIG. 9 illustrates only one possible configuration for synoptic element structured reporting on a computing device 902. Various other architectures and components may be utilized.

Many features of the configurations disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present systems and methods.

Where the described functionality is implemented as computer software, such software may include any type of computer instruction or computer executable code located within a memory device and/or transmitted as electronic signals over a system bus or network. Software that implements the functionality associated with components described herein may include a single instruction, or many instructions, and may be distributed over several different code segments, among different programs, and across several memory devices.

The term “determining” (and grammatical variants thereof) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

Information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

The various illustrative logical blocks and modules described in connection with the configurations disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the configurations disclosed herein may be configured directly in hardware, in a software module executed by a processor, or in a combination of the two. A software module may reside in random-access memory (RAM) memory, flash memory, read-only memory (ROM) memory, erasable programmable ROM (EPROM) memory, electrically EPROM (EEPROM) memory, registers, hard disk, a removable disk, a compact disc ROM (CD-ROM) or any other form of storage medium known in the art (e.g., such as a non-transitory computer-readable). An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein include one or more steps or actions for achieving the described method. The method steps and/or actions may be interchanged with one another without departing from the scope of the present systems and methods. In other words, unless a specific order of steps or actions is required for proper operation of the configuration, the order and/or use of specific steps and/or actions may be modified without departing from the scope of the present systems and methods.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for displaying a family health history on a computing device, comprising:
obtaining a first medical record profile;
obtaining one or more family medical record profiles;
establishing a family link between the first medical record profile and the one or more family medical record profiles, wherein establishing the family link comprises obtaining permission to link the first medical record profile and the one or more family medical record profiles; and
displaying the first medical record profile linked to the one or more family medical record profiles.

2. The method of claim 1, further comprising generating a risk report for the first medical record profile based on the family link between the first medical record profile and the one or more family medical record profiles.

3. The method of claim 2, wherein the risk report is a total risk report based on multiple disease conditions between the first medical record profile and the one or more family medical record profiles.

4. The method of claim 2, wherein the risk report is a disease-specific risk report based on single disease condition between the first medical record profile and the one or more family medical record profiles.

5. The method of claim 1, wherein the first medical record and the one or more family medical record profiles are transmitted using HL7 or GEDCOM format.

6. The method of claim 1, wherein obtaining permission to link the medical record profiles further comprises obtaining permission to access the medical records for each of the medical record profiles.

7. The method of claim 6, wherein obtaining permission to access the medical record profiles comprises obtaining permission to access only a portion of the medical records for each of the medical record profiles related to a specific disease condition.

8. The method of claim 6, wherein obtaining permission to access the medical record profiles comprises obtaining permission for one of the group consisting of a healthcare provider, a disease association, a research study group and a third party application to access the medical record for each of the medical record profiles.

9. The method of claim 1, further comprising displaying a health profile interface of the first medical record profile, wherein the health profile interface comprises multiple fields comprising a personal profile field, a disease condition field and associated disease information of the first medical record profile.

10. The method of claim 1, further comprising displaying each of the first medical record profile and the one or more family medical record profiles, including displaying one or more icons to indicate disease conditions associated with respective medical record profiles.

11. The method of claim 10, wherein at least one of the icons represents a disease category.

12. The method of claim 1, wherein obtaining permission to link the first medical record profile to one or more family medical record profiles comprises:
sending a request for permission to link the first medical record profile to one or more family medical record profiles to a remote device;
receiving permission to link the first medical record profile to one or more family medical record profiles, wherein the permission further comprises a permission to access medical records of the first medical record profile and one or more family medical record profiles.

13. An apparatus for displaying a family health history, the apparatus comprising:
a processor;
memory in electronic communication with the processor; and
instructions stored in the memory, the instructions being executable to:
obtain a first medical record profile;
obtain one or more family medical record profiles;
establish a family link between the first medical record profile and the one or more family medical record profiles, wherein establishing the family link comprises obtaining permission to link the first medical record profile and the one or more family medical record profiles; and
display the first medical record profile linked to the one or more family medical record profiles.

14. The apparatus of claim 13, wherein the instructions are further executable to generate a risk report for the first medical record profile based on the family link between the first medical record profile and the one or more family medical record profiles.

15. The apparatus of claim 13, wherein obtaining permission to link the medical record profiles further comprises obtaining permission to access the medical record for each of the medical record profiles.

16. The apparatus of claim 13, wherein the instructions are further executable to display a health profile interface of the first medical record profile, wherein the health profile interface comprises multiple fields comprising a personal profile field, a disease condition field and associated disease information of the first medical record profile.

17. A non-transitory computer-readable medium for displaying a family health history, comprising executable instructions for:
obtaining a first medical record profile;
obtaining one or more family medical record profiles;
establishing a family link between the first medical record profile and the one or more family medical record profiles, wherein establishing the family link comprises obtaining permission to link the first medical record profile and the one or more family medical record profiles; and
displaying the first medical record profile linked to the one or more family medical record profiles.

18. The non-transitory computer-readable medium of claim 17, further comprising executable instructions for generating a risk report for the first medical record profile based on the family link between the first medical record profile and the one or more family medical record profiles.

19. The non-transitory computer-readable medium of claim 17, wherein the instructions for obtaining permission to access the medical record profile comprises executable instructions for obtaining permission to access only a portion of the medical records for each of the medical record profiles related to a specific disease condition.

20. The non-transitory computer-readable medium of claim 17, further comprising executable instructions for displaying a health profile interface of the first medical record profile, wherein the health profile interface comprises multiple fields comprising a personal profile field, a disease condition field and associated disease information of the first medical record profile.
